(19) United States
(12) Patent Application Publication
(10) Pub. No.: US 2021/0162945 A1
(43) Pub. Date: Jun. 3, 2021

(54) AIR BAG AND AIR BAG DEVICE

(71) Applicant: JOYSON SAFETY SYSTEMS JAPAN K.K., Tokyo (JP)

(72) Inventors: Shinichi TAKEUCHI, Echi-gun, Shiga (JP); Kazuya NAKAMURA, Echi-gun, Shiga (JP)

(73) Assignee: JOYSON SAFETY SYSTEMS JAPAN K.K., Tokyo (JP)

(21) Appl. No.: 16/772,940

(22) PCT Filed: Jan. 8, 2019
(86) PCT No.: PCT/JP2019/000210

§ 371 Date: Jun. 15, 2020

(30) Foreign Application Priority Data
Feb. 7, 2018 (JP) 2018-020221

(51) Int. Cl. B60R 21/233; B60R 21/205; B60R 21/217; B60R 21/26

(52) U.S. Cl. CPC B60R 21/233; B60R 21/205; B60R 2021/23107; B60R 21/26; B60R 21/217

(57) ABSTRACT

Provided is an air bag 1 for a passenger seat, which is inflated and deployed between the passenger seat and an instrument panel. The air bag 1 includes a main bag 2 and a left sub-bag 3 and a right sub-bag 4 connected to the left and right sides of the main bag 2. An extension portion 3A of the left sub-bag 3 expands so as to protrude further rearward than the main bag 2. The left sub-bag 3 communicates with the main bag 2 via communication ports 5 and 6 and the right sub-bag 4 communicates with the main bag 2 via a communication port 15. The communication ports 5 and 15 have substantially the same opening area and are in a substantially symmetrical positional relationship in a left-right direction.

### TECHNICAL FIELD

The present invention relates to an air bag and an air bag device for restraining an occupant of an automobile or the like at the time of a collision. In the invention, front-rear, up-down, and left-right directions correspond to front-rear, up-down, and left-right directions of the vehicle unless otherwise specified.

### BACKGROUND ART

An air bag device has been known that restrains the occupant's body by inflating an air bag around the occupant with an inflator when a vehicle such as an automobile collides or rolls over. For example, an air bag device for a passenger seat is accommodated in an instrument panel, and in an emergency, the air bag is inflated and deployed to restrain an occupant in the passenger seat.

At the time of a diagonal vehicle collision or a small lap collision, the occupant in the passenger seat inertially moves diagonally forward. Therefore, there is a demand for an air bag device for a passenger seat which restrains an occupant in the passenger seat moving diagonally forward.

Patent Literature 1 discloses an air bag for a passenger seat which is inflated and deployed between the passenger seat and an instrument panel and which includes a main bag and a left sub-bag and a right sub-bag connected respectively to left and right sides of the main bag and has a left communication port connecting the inside of the main bag and the inside of the left sub-bag and a right communication port connecting the inside of the main bag and the inside of the right sub-bag, so that gas from the inflator is supplied to the main bag, and then to the left sub-bag and the right sub-bag via the left communication port and the right communication port.

In Patent Literature 1, in inflation completed state, at least a part of a rear portion of the sub-bag on a vehicle center side protrudes further rearward than the rear portion of the main bag. An occupant in the passenger seat, which moves diagonally forward toward the vehicle center due to a diagonal collision, is restrained by the rear part of the sub-bag and the rear part of the main bag.

[Patent Literature 1]: Japanese Patent No. 6183573

### SUMMARY OF INVENTION

An object of the invention is to provide an air bag and an air bag device which includes a main bag and left and right sub-bags and which balances the left and right sub-bags when inflated.

An air bag of the invention is an air bag for a passenger seat, which is inflated and deployed between the passenger seat and an instrument panel, including a main bag and a left sub-bag and a right sub-bag connected respectively to left and right sides of the main bag and a left communication port connecting the left sub-bag and the main bag and a right communication port connecting the right sub-bag and the main bag, in which the left communication port and the right communication port are located below a shoulder level of an occupant and in a substantially symmetrical positional relationship in a left-right direction.

According to an aspect of the invention, when projecting the air bag in side view, at least parts of the left and right communication ports overlap.

According to another aspect of the invention, each communication port is located further rearward than a rear end of the instrument panel.

According to still another aspect of the invention, a volume of one sub-bag is larger than a volume of the other sub-bag.

According to further still another aspect of the invention, an upper portion of a rear portion of the one sub-bag is an extension portion which extends further rearward than a rear surface of the main bag when inflation is completed.

According to further still another aspect of the invention, a lower edge of the extension portion is located between the occupant's shoulder and chin.

According to further still another aspect of the invention, the one sub-bag is provided with a first communication port and a second communication port located further on a front side than the first communication port and having an opening area smaller than that of the first communication port and the first communication port is provided in a substantially symmetrical positional relationship with a communication port of the other sub-bag.

According to further still another aspect of the invention, the first communication port and the communication port of the other sub-bag are provided in the lower part and near a rear surface of each sub-bag.

According to further still another aspect of the invention, the left and right sub-bags have substantially the same inflated thickness below a shoulder level of the occupant.

According to further still another aspect of the invention, a front end of the sub-bag is located in a middle of the main bag in a front-rear direction when the inflation is completed and the main bag has a maximum width portion, where a width in the left-right direction is the maximum, near a front of the sub-bag, and further a width of the main bag in the left-right direction gradually decreases from the maximum width portion toward the rear.

An air bag device of the invention includes the air bag according to the invention and an inflator which supplies gas to the main bag.

### ADVANTAGEOUS EFFECTS OF INVENTION

In the present invention, the left communication port and the right communication port which connect the main bag with the left sub-bag and the right sub-bag are provided at substantially symmetrical positions and below the shoulder level of the occupant. Therefore, the left sub-bag and the right sub-bag are balanced when inflated.

### BRIEF DESCRIPTION OF DRAWINGS

FIG. 1 is a front view (as viewed in a direction of the arrow I-I in FIG. 4) of an air bag device according to an embodiment.

FIG. 2A is a left side view (as viewed in a direction of the arrow IIa-IIa in FIG. 1) of an air bag according to the embodiment and FIG. 2B is a right side view (as viewed in a direction of the arrow IIb-IIb in FIG. 1) of the air bag according to the embodiment.

FIG. 3A is a cross-sectional view taken along the line in FIG. 1 and FIG. 3B is a cross-sectional view taken along the line IIIb-IIIb.

FIG. 4 is a top view (as viewed in a direction of the arrow IV-IV in FIG. 2A) illustrating the air bag according to the embodiment.

FIG. 5 is a cross-sectional view taken along the line V-V in FIG. 2A.

### DESCRIPTION OF EMBODIMENTS

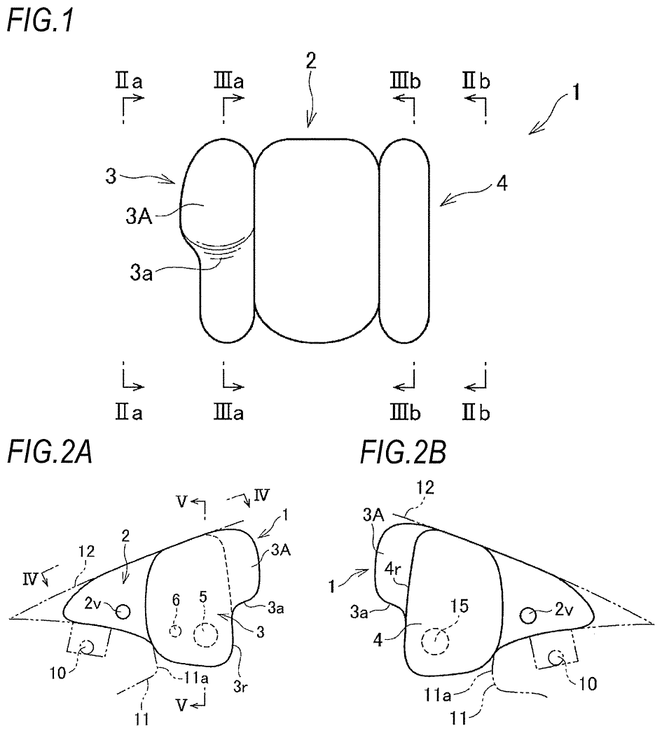

Hereinafter, an air bag and an air bag device according to an embodiment will be described with reference to FIGS. 1 to 5.

The air bag device according to the embodiment includes an air bag 1 which is normally folded and inflated and deployed in an emergency and an inflator 10 (FIGS. 2A and 2B) which supplies gas to the air bag 1. This air bag device is an air bag device for a passenger seat and is accommodated in an instrument panel 11 arranged in front of the passenger seat. The air bag 1 is inflated and deployed in a space surrounded by an occupant, the instrument panel 11, and a windshield 12.

The air bag 1 includes a main bag 2, a left sub-bag 3 connected to a left side of the main bag 2, and a right sub-bag 4 connected to a right side. In this embodiment, the automobile is a left-hand drive car and the passenger seat is a right-hand seat. The left side surface of the air bag 1 is a side surface of the air bag 1 on a vehicle body center side. When mounted on a right-hand drive vehicle, the air bag 1 has a symmetrical configuration as shown.

The main bag 2 is inflated and deployed almost in front of the occupant. In the inflation completed state, a rear surface (occupant-facing surface) 2r of the main bag 2 has a substantially square shape when viewed from the occupant side and faces an upper body including the occupant's head when the inflation and deployment of the air bag 1 is completed.

An insertion port for an inflator 10 is provided on the lower surface of the front part of the main bag 2 in the inflation completed state and gas is supplied from the inflator 10 into the main bag 2.

Vent holes 2v are respectively provided at the front portions (portions located further on the front sides than the front ends of the sub-bags 3 and 4) of the left and right side surfaces of the main bag 2.

The left sub-bag 3 is provided along the rear part of the left side surface of the main bag 2. Most of the left sub-bag 3 is disposed behind a rear end 11a of the instrument panel 11.

The upper part of the rear part of the left sub-bag 3 is an extension portion 3A which extends further rearward than the rear surface 2r of the main bag 2. A lower edge 3a of the extension portion 3A has a height located between the shoulder and the chin of the occupant of the standard body type. The extension portion 3A preferably extends 10 cm to 30 cm behind the rear surface 2r of the main bag 2 when the inflation is completed. In the inflation completed state, the rear surface 3r of the lower part of the left sub-bag, which is the part located further on the lower side than the extension portion 3A, is located at the same front-rear position (the same level) as the rear surface 2r of the main bag 2, but may be located slightly behind (for example, about 10 cm or less) the rear surface 2r.

In the embodiment, the left-right width (inflation thickness) of the upper portion (a portion located above the level of the extension portion lower edge 3a) of the left sub-bag 3 in the inflation completed state is greater than the inflation thickness of the portion located below the level of the extension portion lower edge 3a. This is because a large reaction force is applied when the extension portion 3A receives the occupant's head during a diagonal collision. The left sub-bag 3 has a larger volume than the right sub-bag 4.

A first communication port 5 and a second communication port 6 are provided to communicate between the inside of the left sub-bag 3 and the inside of the main bag 2. The communication ports 5 and 6 are located below the level of the extension portion lower edge 3a and behind the rear end 11a of the instrument panel 11. The communication port 5 is located behind the communication port 6. The communication port 5 has a larger diameter than the communication port 6. In the embodiment, the heights of the communication ports 5 and 6 are substantially equal.

As illustrated in FIG. 5, the left sub-bag 3 and the main bag 2 are sewn with a suture thread 5a at the periphery of the communication port 5. The left sub-bag 3 and the main bag 2 are also sewn with a suture (not illustrated) also at the periphery of the communication port 6.

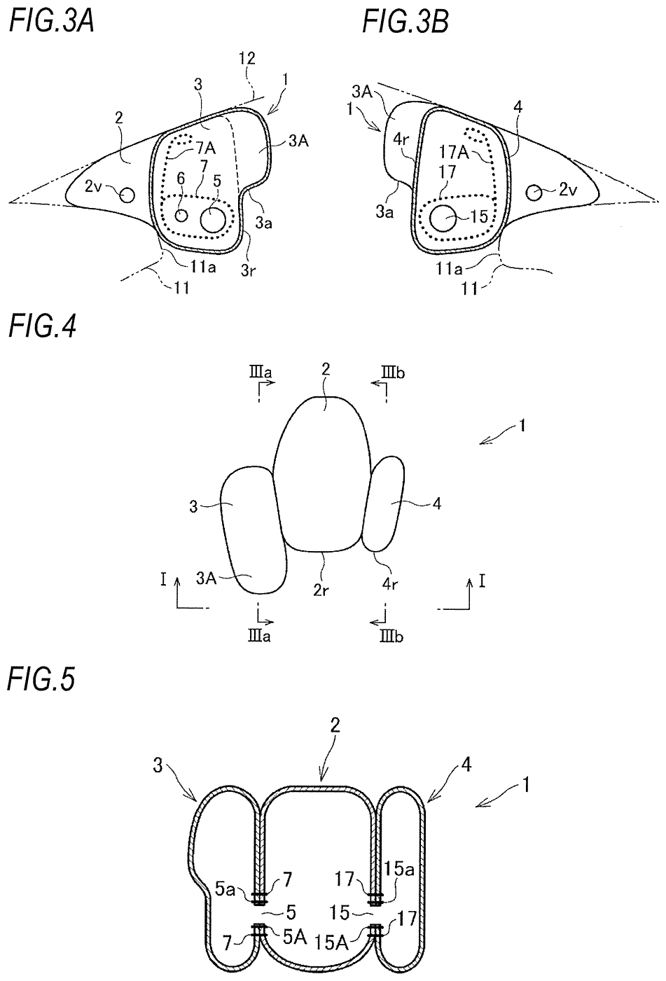

As illustrated in FIGS. 3A and 3B, the left sub-bag 3 and the main bag 2 are sewn by a suture thread 7 which goes around the communication ports 5 and 6. The suture thread 7 passes around the upper side of the communication ports 5 and 6, the rear side of the communication port 5, the lower side of the communication ports 5 and 6, and the front side of the communication port 6. The suture 7 is connected to a suture thread 7A extending further upward from the front side of the communication port 6. The suture 7A extends along the front surface of the left sub-bag 3 to the upper portions of the left sub-bag 3 and the main bag 2.

The right sub-bag 4 is provided along the rear portion of the right side surface of the main bag 2. Most of the right sub-bag 4 is disposed behind the rear end 11a of the instrument panel 11. In the inflation completed state, the rear surface 4r of the right sub-bag 4 is the same level as the rear surface 2r of the main bag 2 as a whole, or located slightly behind (for example, about 10 cm or less) the rear surface 2r.

A communication port 15 is provided so as to communicate between the inside of the right sub-bag 4 and the inside of the main bag 2. As illustrated in FIG. 5, the right sub-bag 4 and the main bag 2 are sewn with a suture thread 15a at the peripheral edge of the communication port 15.

The communication ports 5 and 15 have substantially the same size. The same size means that the opening areas are the same within an error range of ±25%. In this embodiment, the communication ports 5, 15 are provided in a substantially symmetrical positional relationship. The term “substantially symmetric” means that in the side view (FIGS. 2A and 2B) of the air bag 1 in the inflation completed state, at least parts of the communication ports 5 and 15 have a positional relationship overlapping.

Similarly to the left sub-bag 3, the right sub-bag 4 is sewn to the main bag 2 by a suture thread 17 which goes around the communication port 15. The suture thread 17 passes around the upper, rear, lower, and front sides of the communication port 15. The suture thread 17 is connected to a suture thread 17A extending further upward. The suture thread 17A extends along the front surface of the right sub-bag 4 to the top of the right sub-bag 4 and the main bag 2. A part of the suture thread 17, which is the part located on the front side of the communication port 15, extends vertically along the front surface of the right sub-bag 4, as similar to the suture thread 17A.

The suture thread 7 and 7A and the suture thread 17 and 17A are provided in a substantially symmetrical positional relationship.

The thickness of the lower portion of the right sub-bag 4 in the inflation completed state is almost the same as the thickness of the lower portion (the portion below the level of the extension portion lower edge 3a) of the left sub-bag 3. That is, in the lower parts (lower than the occupant's shoulder level) of the sub-bags 3 and 4, the expansion thicknesses of the sub-bags 3 and 4 in a left-right direction in a horizontal cross section are substantially equal (they match within an error range of ±10%). As a result, the restraining forces (reaction forces applied to the left and right shoulders) against the left and right shoulders of the occupant at the time of a frontal collision become substantially equal.

In the embodiment, as illustrated in the top view (FIG. 4) in the inflation completed state, the main bag 2 has the maximum width in the left-right direction near the instrument panel rear end 11a. The width in the left-right direction gradually decreases as it goes from the vicinity of the instrument panel rear end 11a toward the front side and the rear side.

Further, the left and right width of the main bag 2 gradually decreases as it goes further rearward than the maximum width portion. The intersection angle between the extension lines obtained by extending the left and right side surfaces of the main bag 2 toward the rear of the vehicle in FIG. 4 is, for example, about 20° to 60° (deg).

In the inflation completed state, the distance between the left and right communication ports 5 and 15 of the main bag 2 is about 25 cm to 50 cm.

In the air bag device having the air bag 1 configured as described above, when the inflator 10 operates, gas is supplied from the inflator 10 into the main bag 2. The gas supplied into the main bag 2 is supplied into the sub-bags 3 and 4 through the communication ports 5 and 6 and the communication port 15. As a result, the main bag 2 and the sub-bags 3 and 4 are inflated and deployed. In this air bag 1, the communication ports 5 and 15 of substantially the same size are provided at substantially symmetrical positions and below the shoulder level of the occupant. Therefore, when the left sub-bag 3 and the right sub-bag 4 are inflated and deployed, they are balanced, and thus the air bag 1 has a stable final developed shape in a short time.

In the embodiment, since the left and right communication ports 5 and 15 have the same position and the same area, there is no great difference in how the base clothes around the communication ports extend when the occupant is restrained. As a result, the bags are likely to be crushed in the same manner and the occupant can be received in a balanced manner.

In the embodiment, in the lower surface of the main bag 2, a portion located further on the front side than the vicinities of the front portions of the sub-bags 3 and 4 abuts on the instrument panel 11. Further, the lower surfaces of the front portions of the sub-bags 3 and 4 also abut on the instrument panel 11. This stabilizes the support of the main bag 2 and the sub-bags 3 and 4 by the instrument panel 11. Further, the width of the main bag 2 in the left-right direction is gradually reduced as it goes from the vicinity of the middle in the front-rear direction toward the rear and the front, whereby the volume of the main bag 2 can be reduced.

During a frontal collision, the occupant is restrained by the main bag 2 and the sub-bags 3 and 4.

In the case of a diagonal collision to the left of the vehicle or a minute lap collision, the occupant moves diagonally forward left and is restrained by the left sub-bag 3 and the main bag 2. Since the extension portion 3A of the sub-bag 3 is located rearward of the rear surface 2r of the main bag 2, the head of the occupant is restrained so as to enter between the main bag 2 and the extension portion 3A of the sub-bag 3. In the embodiment, since the sub-bag 3 is sewn to the main bag 2 by the suture threads 7 and 7A, when the head pushes the extension portion 3A diagonally leftward and forward, the left sub-bag 3 is prevented from separating from the main bag 2.

In the case of a diagonal collision to the right of the vehicle or a small lap collision, the occupant is restrained by the main bag 2 and the right sub-bag 4.

In the embodiment, the volume of the left sub-bag 3 is larger than that of the right sub-bag 4, but the total opening area of the communication ports 5 and 6 is larger than the opening area of the communication port 15. Therefore, the inflation of the sub-bags 3 and 4 is completed almost at the same time. Therefore, the air bag 1 is prevented from swaying to the left and right or up and down when inflated and deployed.

In the embodiment, the communication ports 5 and 15 are provided near the rear surfaces 3r and 4r of the sub-bags 3 and 4, respectively. Therefore, the gas flowing into the main bag 2 from the inflator 10 easily flows into the sub-bags 3 and 4 from the communication ports 5 and 15 early. That is, the gas from the inflator 10 tends to flow rearward along the upper surface of the main bag 2 along the windshield 12, and then downward along the rear surface 2r of the main bag 2. Since the communication ports 5 and 15 are provided near the rear surfaces 3r and 4r, the gas flowing downward along the rear surface 2r of the main bag 2 reaches the communication ports 5 and 15 early and flows into the sub-bags 3 and 4 early. Therefore, the expansion and deployment of the sub-bags 3 and 4 is completed early.

In the invention, either of both the left and right communication ports 5, 15 may be provided with a check valve structure. A sub-chamber with a check valve at the communication port has the following effects because it has a higher pressure than a sub-chamber without a check valve.

(1) For an occupant entering diagonally, the high-pressure sub-chamber corrects the entering trajectory to the front.

(2) For an occupant entering in the front direction, equipping both communication ports on the left and right sides with check valves allows the shoulders to be restrained in a well-balanced manner. The head can be received softer than an air bag which does not have a check valve.

In the embodiment described above, the communication port has a substantially perfect circle, but is not limited to this. For example, the communication port may be a substantially oval shape extending in the front-rear direction. In this case, when the communication port has a shape in which the vertical width is larger on the front side than on the rear side, gas easily flows in from the front side of the vehicle, so that swinging of the bag is reduced and deployment is easily stabilized.

The invention is not limited to the embodiment described above and it goes without saying that various modifications can be made without departing from the spirit of the invention. For example, in the invention, the curvature of the expanded sub-chamber may be increased by putting a tack in a panel forming the sub-bag. Further, the curvature of the expanded sub-chamber may be increased by providing a knob on one of the panels forming the sub-bag which faces the main bag. The sub-chamber may be one in which the edges of a plurality of panels are sewn together or may be one in which one panel is folded back and the edges are sewn together.

Although the invention is described in detail using the specific embodiment, it will be apparent to those skilled in the art that various modifications can be made without departing from the spirit and scope of the invention.

This application is based on Japanese Patent Application 2018-020221 filed on Feb. 7, 2018, which is incorporated by reference in its entirety.

### REFERENCE SIGNS LIST

1: air bag

2: main bag

3: left sub-bag

3A: extension portion

3a: extension portion lower edge

4: right sub-bag

5, 6, 15: communication port

10: inflator

11: instrument panel

12: windshield

1. An air bag for a passenger seat which is inflated and deployed between the passenger seat and an instrument panel comprising:
a main bag;
a left sub-bag and a right sub-bag connected respectively to left and right sides of the main bag; and
a left communication port connecting the left sub-bag and the main bag and a right communication port connecting the right sub-bag and the main bag, wherein
the left communication port and the right communication port are located below a shoulder level of an occupant and in a substantially symmetrical positional relationship in a left-right direction.

2. The air bag according to claim 1, wherein
when projecting the air bag in a side view, at least parts of the left and right communication ports overlap.

3. The air bag according to claim 1, wherein
each communication port is located further rearward than a rear end of the instrument panel.

4. The air bag according to claim 1, wherein
a volume of one sub-bag is larger than a volume of the other sub-bag.

5. The air bag according to claim 4, wherein
an upper portion of a rear portion of the one sub-bag is an extension portion which extends further rearward than a rear surface of the main bag when inflation is completed.

6. The air bag according to claim 5, wherein
a lower edge of the extension portion is located between the occupant's shoulder and chin.

7. The air bag according to claim 4, wherein
the one sub-bag is provided with a first communication port and a second communication port located further on a front side than the first communication port and having an opening area smaller than that of the first communication port, and
the first communication port is provided in a substantially symmetrical positional relationship with a communication port of the other sub-bag.

8. The air bag according to claim 6, wherein
the first communication port and the communication port of the other sub-bag are provided in a lower part and near a rear surface of each sub-bag.

9. The air bag according to claim 1, wherein
the left and right sub-bags have substantially the same inflated thickness below a shoulder level of the occupant.

10. The air bag according to claim 1, wherein
a front end of the sub-bag is located in a middle of the main bag in a front-rear direction when the inflation is completed,
the main bag has a maximum width portion, where a width in the left-right direction is the maximum, near a front of the sub-bag, and
a width of the main bag in the left-right direction gradually decreases from the maximum width portion toward the rear.

11. An air bag device, comprising:
the air bag according to claim 1, and
an inflator which supplies gas to the main bag.
